(19) United States
(12) Patent Application Publication
(10) Pub. No.: US 2024/0157843 A1
(43) Pub. Date: May 16, 2024

(54) APPARATUS AND METHOD FOR CONTROLLING VEHICLE

(71) Applicants: Hyundai Motor Company, Seoul (KR); Kia Corporation, Seoul (KR); YURA CORPORATION CO.,LTD., Seongnam-si (KR)

(72) Inventors: Kang Woo BAE, Suwon-Si (KR); Jae Min KWON, Siheung-Si (KR); Chan Young JUNG, Yongin-Si (KR); Bo Ko CHOI, Cheonan-Si (KR)

(73) Assignees: Hyundai Motor Company, Seoul (KR); Kia Corporation, Seoul (KR); YURA CORPORATION CO.,LTD., Seongnam-si (KR)

(21) Appl. No.: 18/226,670

(22) Filed: Jul. 26, 2023

(30) Foreign Application Priority Data
Nov. 14, 2022 (KR) 10-2022-0151663

(51) Int. Cl. B60L 58/12; B60L 1/00; B60L 53/18

(52) U.S. Cl. CPC B60L 58/12; B60L 1/00; B60L 53/18; B60L 2210/10

(57) ABSTRACT

An apparatus for controlling a vehicle includes a relay which is controlled to close to supply a power from a battery to an electric field load or is controlled to open to block the power, a sensor that detects a state of charge (SOC) value of the battery and opening and closing of a door of the vehicle, and a controller that is configured to control the relay to close based on the power supplied from the battery or a power of an external power device, when the controller concludes that the SOC value of the battery is less than a first reference value and that the door is opened, and charges the battery with the power supplied from the external electronic device.

### CROSS-REFERENCE TO RELATED APPLICATION

The present application claims priority to Korean Patent Application No. 10-2022-0151663, filed on Nov. 14, 2022, the entire contents of which is incorporated herein for all purposes by this reference.

### BACKGROUND OF THE PRESENT DISCLOSURE

### Field of the Present Disclosure

The present disclosure relates to an apparatus and a method for controlling a vehicle.

### Description of Related Art

A battery loaded into a vehicle is replaced from a lead acid battery to a lithium iron phosphate battery for energy efficiency and safety. The lithium iron phosphate battery is loaded into the vehicle together with a battery management system to prevent overheating when being charged and maintain cell balance. When the battery state of charge (SOC) is less than a reference value or when overvoltage, overcurrent, or overtemperature is detected, the battery management system opens a relay and blocks power supplied from the lithium iron phosphate battery to an electric field load to protect the battery.

However, when the door of the vehicle is opened and closed in the state where the power of the battery is blocked, the battery management system temporarily supplies power required for an operation (e.g., ON of a vehicle light or the like) performed in response to the opening and closing of the door to the electric field load. At the instant time, when power is continuously supplied to the electric field load in the state where the vehicle is not turned on, the lithium iron phosphate battery is fully discharged.

Because the relay is opened in the state where the power of the battery is blocked and because it is unable to charge the battery although power is supplied using an external electronic device (e.g., a start jump device), the relay is unable to be controlled and there is a limitation that there is no alternative other than replacing the battery.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for controlling a vehicle to block power supplied from a battery to protect a lithium iron phosphate battery and only temporarily supply power for relay control so that the battery is not discharged.

Another aspect of the present disclosure provides an apparatus and a method for controlling a vehicle to control a relay so that a lithium iron phosphate battery is charged by an external electronic device, although power supplied from the battery is blocked to protect the battery.

Another aspect of the present disclosure provides an apparatus and a method for controlling a vehicle to control a relay depending on the SOC value of a lithium iron phosphate battery to protect the battery.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a vehicle may include a relay which is controlled to close to supply a power from a battery to an electric field load or is controlled to open to block the power, a sensor that detects a state of charge (SOC) value of the battery and opening and closing of a door of the vehicle, and a controller that is configured to control the relay to close based on the power supplied from the battery or a power of an external power device, when the controller concludes that the SOC value of the battery is less than a first reference value and that the door is opened, and charges the battery with the power supplied from the external electronic device.

In an exemplary embodiment of the present disclosure, the controller may be configured to control the relay to open, when the controller concludes that the external electronic device is not connected to the apparatus within a predetermined time period after controlling the relay to close based on the power supplied from the battery.

In an exemplary embodiment of the present disclosure, the controller may be configured to control the relay to open, when the controller concludes that the battery is not being charged after controlling the relay to close based on the power supplied from the external electronic device.

In an exemplary embodiment of the present disclosure, the controller may be configured to control the relay to open, when the controller concludes that the SOC value of the battery is greater than or equal to a second reference value greater than the first reference value due to charging of the battery using the power supplied from the external electronic device.

In an exemplary embodiment of the present disclosure, the controller may be configured to determine whether the SOC value of the battery is greater than a third reference value less than the second reference value, when the controller concludes that a connection of the external electronic device to the apparatus is released after controlling the relay to open.

In an exemplary embodiment of the present disclosure, the controller may be configured to control the relay to close, when the controller concludes that the SOC value of the battery is greater than the third reference value less than the second reference value.

In an exemplary embodiment of the present disclosure, the controller may be configured to control the relay to open, when the controller concludes that the SOC value of the battery is less than or equal to the third reference value less than the second reference value.

In an exemplary embodiment of the present disclosure, the controller may be configured to determine whether a connection of the external electronic device to the apparatus is released, when the controller concludes that the SOC value of the battery is less than a second reference value greater than the first reference value due to charging of the battery using the power supplied from the external electronic device.

In an exemplary embodiment of the present disclosure, the controller may charge the battery using the power supplied from the external electronic device, when the controller concludes that the connection of the external electronic device to the apparatus is not released, in a state where the SOC value of the battery is less than the second reference value greater than the first reference value.

According to another aspect of the present disclosure, a method for controlling a vehicle may include controlling, by a controller, a relay to close based on a power supplied from a battery or a power supplied from an external electronic device, when the controller concludes that an SOC value of the battery is less than a first reference value and a door of the vehicle is opened and charging, by the controller, the battery with the power supplied from the external electronic device.

In an exemplary embodiment of the present disclosure, the method may further include controlling, by the controller, the relay to open, when the controller concludes that the external electronic device is not connected to the apparatus within a predetermined time period after controlling the relay to close based on the power supplied from the battery.

In an exemplary embodiment of the present disclosure, the method may further include controlling, by the controller, the relay to open, when the controller concludes that the battery is not being charged after controlling the relay to close based on the power supplied from the external electronic device.

In an exemplary embodiment of the present disclosure, the method may further include controlling, by the controller, the relay to open, when the controller concludes that the SOC value of the battery is greater than or equal to a second reference value greater than the first reference value due to charging of the battery using the power supplied from the external electronic device.

In an exemplary embodiment of the present disclosure, the method may further include determining, by the controller, whether the SOC value of the battery is greater than a third reference value less than the second reference value, when the controller concludes that a connection of the external electronic device to the apparatus is released after controlling the relay to open.

In an exemplary embodiment of the present disclosure, the method may further include controlling, by the controller, the relay to close, when the controller concludes that the SOC value of the battery is greater than the third reference value less than the second reference value.

In an exemplary embodiment of the present disclosure, the method may further include controlling, by the controller, the relay to open, when the controller concludes that the SOC value of the battery is less than or equal to the third reference value less than the second reference value.

In an exemplary embodiment of the present disclosure, the method may further include determining, by the controller, whether a connection of the external electronic device to the apparatus is released, when the controller concludes that the SOC value of the battery is less than a second reference value greater than the first reference value due to charging of the battery using the power supplied from the external electronic device.

In an exemplary embodiment of the present disclosure, the method may further include charging, by the controller, the battery using the power supplied from the external electronic device, when the controller concludes that the connection of the external electronic device to the apparatus is not released, in a state where the SOC value of the battery is less than the second reference value greater than the first reference value.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a configuration of an apparatus for controlling a vehicle according to an exemplary embodiment of the present disclosure:

FIG. 2 is a drawing schematically illustrating an apparatus for controlling a vehicle according to an exemplary embodiment of the present disclosure,

FIG. 3 is a flowchart illustrating a method for controlling a vehicle according to an exemplary embodiment of the present disclosure:

FIG. 4 is a flowchart illustrating a method for controlling a vehicle according to another exemplary embodiment of the present disclosure; and

FIG. 5 is a block diagram illustrating a configuration of a computing system for executing a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding the reference numerals to the components of each drawing, it should be noted that the identical component is designated by the identical numerals even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”. “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

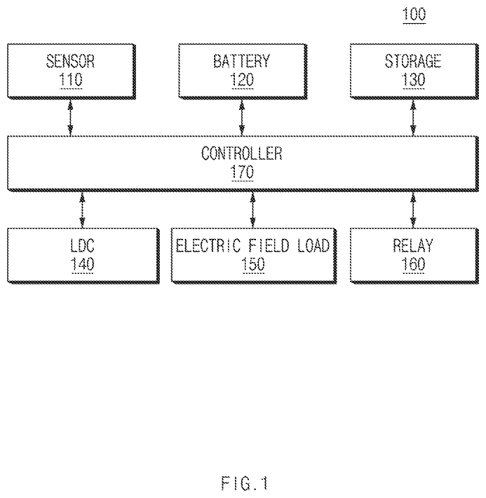

FIG. 1 is a block diagram illustrating a configuration of an apparatus for controlling a vehicle according to an exemplary embodiment of the present disclosure.

As shown in FIG. 1, an apparatus 100 for controlling a vehicle according to an exemplary embodiment of the present disclosure may include a sensor 110, a battery 120, storage 130, and a controller 170.

The sensor 110 may include a battery sensor. The battery sensor may include a voltage sensor configured for detecting a voltage of the battery 120, a current sensor configured for detecting a current of the battery 120, and a temperature sensor configured for detecting a temperature of the battery 120. Furthermore, the sensor 110 may include a door sensor or a bonnet sensor, which detects opening and closing of a door of the vehicle or a bonnet of the vehicle.

The battery 120 may supply power to an electric field load applied to the vehicle and may include a lithium iron phosphate battery for outputting a predetermined voltage.

The storage 130 may store at least one algorithm which determines or executes various commands for an operation of the apparatus 100 for controlling the vehicle according to an exemplary embodiment of the present disclosure. The storage 130 may include at least one of a flash memory, a hard disc, a memory card, a read-only memory (ROM), a random access memory (RAM), an electrically erasable and programmable ROM (EEPROM), a programmable ROM (PROM), a magnetic memory, a magnetic disc, or an optical disc.

A low DC/DC Converter (LDC) 140 may convert a voltage of a high voltage battery into a low voltage (e.g., 12 V) to supply power to an electric field load 150 and may charge the battery 120.

The electric field load 150 may be a low voltage load which operates by power of the low voltage output from the LDC 140 or the battery 120, which may include seat heating wires, internal lights, a radio, navigation, turn signals, tail lamps, headlamps, wipers, a chiller/beater, an anti-lock brake system (ABS), an electric power steering (EPS), and the like, which are loaded into the vehicle.

A relay 160 may include a latching relay. The relay 160 may be controlled to close by the controller 170 to supply power from the battery 120 to the electric field load 150 or may be controlled to open by the controller 170 to block power supplied to the electric field load 150.

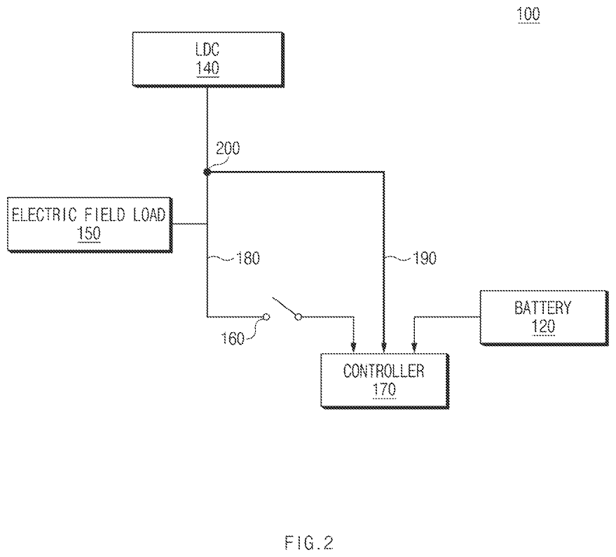

The controller 170 may be implemented by various processing devices, such as a microprocessor, embedding a semiconductor chip or the like configured for determining or executing various commands, and may control an operation of the apparatus 100 for controlling the vehicle according to an exemplary embodiment of the present disclosure. The controller 170 may be electrically connected to the sensor 110, the battery 120, the storage 130, the LDC 140, the electric field load 150, and the relay 160 through a wired cable or various circuits to deliver an electrical signal including a control command or the like and may transmit and receive an electrical signal including a control command or the like over a communication network including Controller Area Network (CAN) communication. A detailed description of the controller 170 refers to FIG. 2.

FIG. 2 is a drawing schematically illustrating an apparatus for controlling a vehicle according to an exemplary embodiment of the present disclosure.

As shown in FIG. 2, when a state of charge (SOC) value of a battery 120 is less than a first reference value, a controller 170 may control a relay 160 to open to prevent the battery 120 from being discharged and may block power output to an electric field load 150 through a first circuit 180.

According an exemplary embodiment of the present disclosure, in the state where the relay 160 is controlled to open and the power output from the battery 120 is blocked, when the opening of the door is detected, the controller 170 may be configured to determine whether an SOC corresponding to power to control the relay 160 to close remains in the battery 120.

When it is determined that the SOC to control the relay 160 to open remains in the battery 120, the controller 170 may temporarily supply power with the SOC remaining in the battery 120 and may control the relay 160 to close.

Hereinafter, first of all, a description will be provided of an operation where the controller 170 temporarily supplies the power with the SOC remaining in the battery 120 and is configured to control the relay 160 to close.

To prevent the SOC which remains in the battery 120 from being continuously supplied and discharged to the electric field load 150 after the relay 160 is controlled to close with the SOC which remains in the battery 120, the controller 170 may be configured to determine whether an external charging device (e.g., a jump start) is connected within a certain time from the time point when the relay 160 is controlled to close. Herein, the certain time may be set according to the SOC which remains in the battery 120.

According an exemplary embodiment of the present disclosure, the external charging device may be connected to an external charging device connection terminal 200 provided on the first circuit 180 which connects between an LDC 140 and the relay 160 and may receive power through a second circuit 190, which connects the external charging device connection terminal 200 with the controller 170, to charge the battery 120.

When it is determined that the door (e.g., a vehicle bonnet) is opened within the certain time from the time point when the relay 160 is controlled to close, the controller 170 may be configured to determine that the external charging device is connected.

When the external charging device is connected, the controller 170 may be configured to determine whether the battery 120 is being charged depending on whether the charging current supplied from the external charging device is greater than or equal to a reference value (e.g., 1 A).

When it is determined that the charging current is greater than or equal to the reference value, the controller 170 may be configured to determine that the battery 120 is being charged. When it is determined that the battery 120 is being charged, the controller 170 may be configured to determine whether the SOC value of the battery 120 is less than a second reference value (e.g., 95%).

Meanwhile, when it is determined that the door (e.g., the vehicle bonnet) is not opened within the certain time from the time point when the relay 160 is controlled to close, the controller 170 may be configured to determine that the external charging device is not connected.

When it is determined that the external charging device is not connected within the certain time, to prevent the battery 120 from being discharged, the controller 170 may control the relay 160 to open to block power output from the battery 120 to the electric field load 150.

When it is determined that the SOC value of the battery 120 is less than the second reference value, the controller 170 may monitor a voltage, a current, and a temperature of the battery 120.

When it is determined that the SOC value of the battery 120 is not less than the second reference value, that is, that the SOC value of the battery 120 is greater than the second reference value, the controller 170 may control the relay 160 to open to prevent the battery 120 from being overcharged. After the relay 160 is controlled to open, the controller 170 may be configured to determine whether the connection of the external charging device is released.

The controller 170 may monitor a voltage V, a current I, and a temperature T of the battery 120 and may be configured to determine whether the connection of the external charging device is released. According an exemplary embodiment of the present disclosure, when it is determined that the charging current is less than the reference value and the closing of the door is detected, the controller 170 may be configured to determine that the connection of the external charging device is released.

When the connection of the external charging device is released, the controller 170 may be configured to determine whether the SOC value of the battery 120 is greater than a third reference value (e.g., 10%).

When it is determined that the SOC value of the battery 120 is greater than the third reference value, the controller 170 may be configured to determine that power capable of being supplied from the battery 120 to the electric field load 150 is sufficient and may control the relay 160 to close to supply power to the electric field load 150.

Meanwhile, when it is determined that the SOC value of the battery 120 is not greater than the third reference value, the controller 170 may be configured to determine that power capable of being supplied from the battery 120 to the electric field load 150 is not sufficient and may control the relay 160 to open to block power to the electric field load 150 to prevent the battery 120 from being discharged.

According another exemplary embodiment of the present disclosure, hereinafter, when it is determined that the SOC to control the relay 160 to open does not remain in the battery 120, the controller 170 may allow the user to recognize the situation in which the SOC to control the relay 160 to close does not remain in the battery 120. For example, even when the opening of the vehicle door is detected, the controller 170 may allow the internal lights of the vehicle not to be turned on or may allow a welcome sound or the like not to be output, thus allowing the user to recognize the situation in which the SOC to control the relay 160 to close does not remain in the battery 120.

When the opening of the door is detected, the controller 170 may be configured to determine whether the external charging device connection terminal 200 and the external charging device are connected to each other.

When it is determined that the external charging device connection terminal 200 and the external charging device are connected to each other, the controller 170 may control the relay 160 to close using power supplied from the external charging device.

When the external charging device is connected, the controller 170 may be configured to determine whether the battery 120 is being charged depending on whether the charging current supplied from the external charging device to the battery 120 is greater than or equal to a reference value (e.g., 1 A).

When it is determined that the charging current is greater than or equal to the reference value, the controller 170 may be configured to determine that the battery 120 is being charged. When it is determined that the battery 120 is being charged, the controller 170 may be configured to determine whether the SOC value of the battery 120 is less than the second reference value (e.g., 95%).

Meanwhile, when the charging current supplied from the external charging device is less than the reference value, the controller 170 may be configured to determine that the battery 120 is not being charged and may control the relay 160 to open to block power output from the battery 120 to the electric field load 150 to prevent the battery 120 from being discharged.

When it is determined that the SOC value of the battery 120 is less than the second reference value, the controller 170 may monitor a voltage, a current, and a temperature of the battery 120.

Meanwhile, when it is determined that the SOC value of the battery 120 is not less than the second reference value, that is, that the SOC value of the battery 120 is greater than the second reference value, the controller 170 may control the relay 160 to open to prevent the battery 120 from being overcharged. After the relay 160 is controlled to open, the controller 170 may be configured to determine whether the connection of the external charging device is released.

After monitoring the voltage, the current, and the temperature of the battery 120, the controller 170 may be configured to determine whether the connection of the external charging device is released. According an exemplary embodiment of the present disclosure, when it is determined that the charging current is less than the reference value and the closing of the door is detected, the controller 170 may be configured to determine that the connection of the external charging device is released.

When the connection of the external charging device is released, the controller 170 may be configured to determine whether the SOC value of the battery 120 is greater than the third reference value (e.g., 10%).

When it is determined that the SOC value of the battery 120 is greater than the third reference value, the controller 170 may be configured to determine that power capable of being supplied from the battery 120 to the electric field load 150 is sufficient and may control the relay 160 to close to supply power to the electric field load 150.

Meanwhile, when it is determined that the SOC value of the battery 120 is not greater than the third reference value, the controller 170 may be configured to determine that power capable of being supplied from the battery 120 to the electric field load 150 is not sufficient and may control the relay 160 to open to block power to the electric field load 150 to prevent the battery 120 from being discharged.

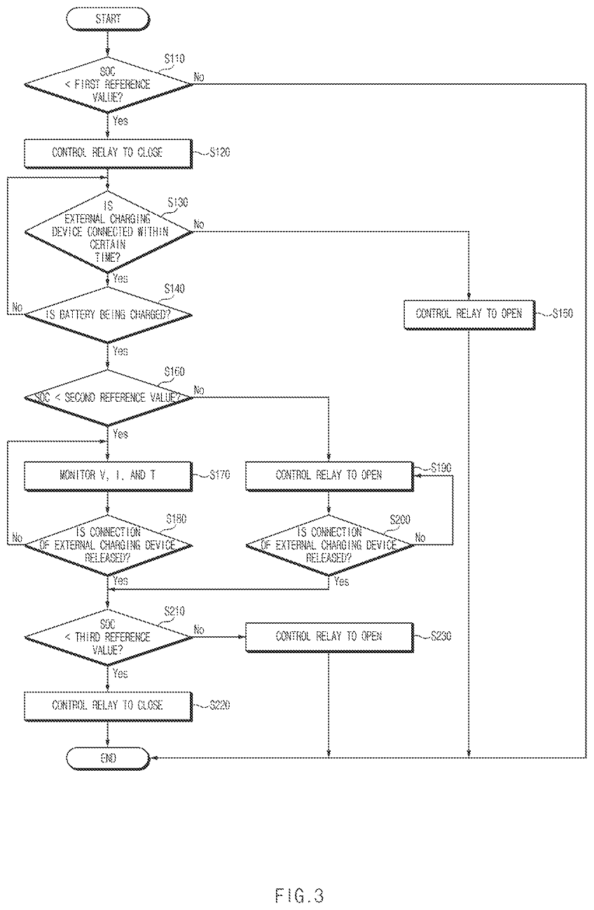

FIG. 3 is a flowchart illustrating a method for controlling a vehicle according to an exemplary embodiment of the present disclosure.

As shown in FIG. 3, in S10, a controller 170 of FIG. 1 or 2 may be configured to determine whether an SOC value of a battery 120 of FIG. 1 or 2 is less than a first reference value. When it is determined that the SOC is not less than the first reference value in S110, the controller 170 may be configured to determine that the battery 120 is overcharged to end the operation to protect the battery 120.

When the SOC value of the battery 120 is less than the first reference value in S110, the controller 170 may control the relay 160 to open to prevent the battery 120 from being discharged.

According an exemplary embodiment of the present disclosure, in the state where the relay 160 is controlled to open and the power output from the battery 120 is blocked, when the opening of the vehicle door is detected, the controller 170 may be configured to determine whether an SOC corresponding to power to control the relay 160 to close remains in the battery 120.

When it is determined that the SOC to control the relay 160 to open remains in the battery 120, in S120, the controller 170 may temporarily supply power with the SOC remaining in the battery 120 and may control the relay 160 to close.

To prevent the SOC which remains in the battery 120 from being continuously supplied and discharged to the electric field load 150 after the relay 160 is controlled to close with the SOC which remains in the battery 120, in S130, the controller 170 may be configured to determine whether an external charging device (e.g., a jump start) is connected within a certain time from the time point when the relay 160 is controlled to close. Herein, the certain time may be set according to the SOC which remains in the battery 120.

According to an exemplary embodiment of the present disclosure, when it is determined that the door (e.g., a vehicle bonnet) is opened within the certain time from the time point when the relay 160 is controlled to close in S130, the controller 170 may be configured to determine that the external charging device is connected.

When it is determined that the external charging device is connected in S130, in S140, the controller 170 may be configured to determine whether the battery 120 is being charged depending on whether the charging current supplied from the external charging device is greater than or equal to a reference value (e.g., 1 A).

According an exemplary embodiment of the present disclosure, when it is determined that the charging current is greater than or equal to the reference value, the controller 170 may be configured to determine that the battery 120 is being charged.

When it is determined that the battery 120 is being charged in S140, in S160, the controller 170 may be configured to determine whether the SOC value of the battery 120 is less than a second reference value (e.g., 95%).

Meanwhile, when it is determined that the door (e.g., the vehicle bonnet) is not opened within the certain time from the time point when the relay 160 is controlled to close in the S130, the controller 170 may be configured to determine that the external charging device is not connected.

When it is determined that the external charging device is not connected within the certain time in S130, in S150, the controller 170 may control the relay 160 to open to prevent the battery 120 from being discharged. Accordingly, when it is determined that the external charging device is not connected within the certain time, in S150, the controller 170 may block power output from the battery 120 to the electric field load 150.

When it is determined that the SOC value of the battery 120 is less than the second reference value in S160, in S170, the controller 170 may monitor a voltage, a current, and a temperature of the battery 120.

Meanwhile, when it is determined that the SOC value of the battery 120 is not less than the second reference value in S160, that is, that the SOC value of the battery 120 is greater than the second reference value, in S190, the controller 170 may control the relay 160 to open to prevent the battery 120 from being overcharged. After the relay 160 is controlled to open, in S200, the controller 170 may be configured to determine whether the connection of the external charging device is released.

After monitoring the voltage, the current, and the temperature of the battery 120, in S180, the controller 170 may be configured to determine whether the connection of the external charging device is released.

According an exemplary embodiment of the present disclosure, when it is determined that the charging current is less than the reference value and the closing of the door (e.g., the vehicle bonnet) is detected in S180 or S200, the controller 170 may be configured to determine that the connection of the external charging device is released.

When it is determined that the connection of the external charging device is released in S180 or S200, in S210, the controller 170 may be configured to determine whether the SOC value of the battery 120 is greater than a third reference value (e.g., 10%).

When it is determined that the SOC value of the battery 120 is greater than the third reference value in S210, in S220, the controller 170 may be configured to determine that power capable of being supplied from the battery 120 to the electric field load 150 is sufficient and may control the relay 160 to close. Accordingly, the controller 170 may supply power to the electric field load 150.

Meanwhile, when it is determined that the SOC value of the battery 120 is not greater than the third reference value in S210, in S230, the controller 170 may be configured to determine that power capable of being supplied from the battery 120 to the electric field load 150 is not sufficient and may control the relay 160 to open to prevent the battery 120 from being discharged. Accordingly, the controller 170 may block power supplied to the electric field load 150.

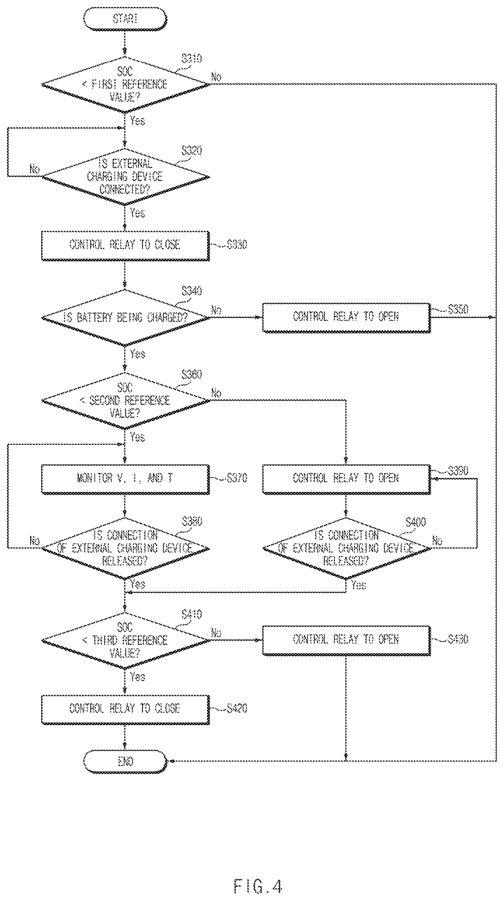

FIG. 4 is a flowchart illustrating a method for controlling a vehicle according to another exemplary embodiment of the present disclosure.

As shown in FIG. 4, in S310, a controller 170 of FIG. 1 or 2 may be configured to determine whether an SOC value of a battery 120 of FIG. 1 or 2 is less than a first reference value. When it is determined that the SOC is not less than the first reference value in S310, the controller 170 may be configured to determine that the battery 120 is overcharged to end the operation to protect the battery 120.

When the SOC value of the battery 120 is less than the first reference value in S310, the controller 170 may control the relay 160 to open to prevent the battery 120 from being discharged.

According an exemplary embodiment of the present disclosure, in the state where the relay 160 is controlled to open and the power output from the battery 120 is blocked, when the opening of the vehicle door is detected, the controller 170 may be configured to determine whether an SOC corresponding to power to control the relay 160 to close remains in the battery 120.

When it is determined that the SOC to control the relay 160 to open does not remain in the battery 120, the controller 170 may allow the user to recognize the situation in which the SOC to control the relay 160 to close does not remain in the battery 120. For example, even when the opening of the vehicle door is detected, the controller 170 may allow the internal lights of the vehicle not to be turned on or may allow a welcome sound or the like not to be output, thus allowing the user to recognize the situation in which the SOC to control the relay 160 to close does not remain in the battery 120.

When detecting the opening of a door (e.g., a vehicle bonnet) for a connection of an external charging device (e.g., a jump start), in S320, the controller 170 may be configured to determine whether an external charging device connection terminal 200 and the external charging device are connected to each other.

When it is determined that the external charging device connection terminal 200 and the external charging device are connected to each other in S320, in S330, the controller 170 may control the relay 160 to close using power supplied from the external charging device.

When the external charging device is connected, in S340, the controller 170 may be configured to determine whether the battery 120 is being charged depending on whether the charging current supplied from the external charging device to the battery 120 is greater than or equal to a reference value (e.g., 1 A).

According an exemplary embodiment of the present disclosure, when it is determined that the charging current is greater than or equal to the reference value in S340, the controller 170 may be configured to determine that the battery 120 is being charged.

According an exemplary embodiment of the present disclosure, when the charging current supplied from the external charging device is less than the reference value in 340, the controller 170 may be configured to determine that the battery 120 is not being charged.

When it is determined that the battery 120 is being charged in S340, in S360, the controller 170 may be configured to determine whether the SOC value of the battery 120 is less than a second reference value (e.g., 95%).

When the charging current supplied from the external charging device is less than the reference value and when it is determined that the battery 120 is not being charged in S340, in S350, the controller 170 may control the relay 160 to open to prevent the battery 120 from being discharged.

When it is determined that the SOC value of the battery 120 is less than the second reference value in S350, in S370, the controller 170 may monitor a voltage, a current, and a temperature of the battery 120.

Meanwhile, when it is determined that the SOC value of the battery 120 is not less than the second reference value in S360, that is, that the SOC value of the battery 120 is greater than the second reference value, in S390, the controller 170 may control the relay 160 to open to prevent the battery 120 from being overcharged. After the relay 160 is controlled to open, in S400, the controller 170 may be configured to determine whether the connection of the external charging device is released.

After monitoring the voltage, the current, and the temperature of the battery 120, in S380, the controller 170 may be configured to determine whether the connection of the external charging device is released.

According an exemplary embodiment of the present disclosure, when it is determined that the charging current is less than the reference value and the closing of the door is detected in S380 or S400, the controller 170 may be configured to determine that the connection of the external charging device is released.

When the connection of the external charging device is released in S380 or S400, in S410, the controller 170 may be configured to determine whether the SOC value of the battery 120 is greater than a third reference value (e.g., 10%).

When it is determined that the SOC value of the battery 120 is greater than the third reference value in S410, in S430, the controller 170 may be configured to determine that power capable of being supplied from the battery 120 to the electric field load 150 is sufficient and may control the relay 160 to close. Accordingly, in S430, the controller 170 may supply power to the electric field load 150.

Meanwhile, when it is determined that the SOC value of the battery 120 is not greater than the third reference value in S410, in S420, the controller 170 may be configured to determine that power capable of being supplied from the battery 120 to the electric field load 150 is not sufficient and may control the relay 160 to open to prevent the battery 120 from being discharged. Accordingly, the controller 170 may block power supplied to the electric field load 150.

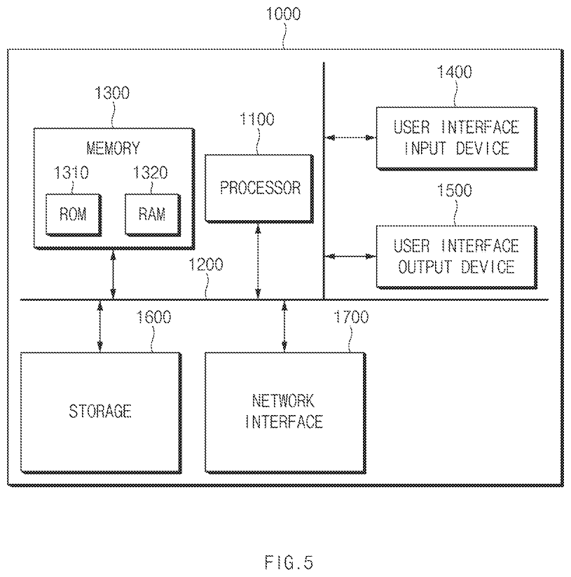

FIG. 5 is a block diagram illustrating a configuration of a computing system for executing a method according to an exemplary embodiment of the present disclosure.

Referring to FIG. 5, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus and the method for controlling the vehicle according to an exemplary embodiment of the present disclosure may charge a lithium iron phosphate battery by an external electronic device by controlling a relay when power supplied from the battery is blocked to protect the battery and may control the relay depending to the SOC value of the battery to protect the battery.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling a vehicle, the apparatus comprising:
a relay configured to be controlled to close to supply a power from a battery to an electric field load or be controlled to open to block the power;
a sensor configured to detect a state of charge (SOC) value of the battery and opening and closing of a door of the vehicle; and
a controller configured to control the relay to close based on the power supplied from the battery or a power of an external power device, when the controller concludes that the SOC value of the battery is less than a first reference value and that the door is opened, and charge the battery with the power supplied from the external electronic device.

2. The apparatus of claim 1, wherein the controller is configured to control the relay to open, when the controller concludes that the external electronic device is not connected to the apparatus within a predetermined time period after controlling the relay to close based on the power supplied from the battery.

3. The apparatus of claim 2, wherein when the controller concludes that external charging device is connected to the apparatus within the predetermined time period after controlling the relay to close based on the power supplied from the battery, the controller is configured to determine whether the battery is being charged depending on whether a charging current supplied from the external charging device is greater than or equal to a reference value.

4. The apparatus of claim 1, wherein the controller is configured to control the relay to open, when the controller concludes that the battery is not being charged after controlling the relay to close based on the power supplied from the external electronic device.

5. The apparatus of claim 1, wherein the controller is configured to control the relay to open, when the controller concludes that the SOC value of the battery is greater than or equal to a second reference value greater than the first reference value due to charging of the battery using the power supplied from the external electronic device.

6. The apparatus of claim 5, wherein the controller is configured to determine whether the SOC value of the battery is greater than a third reference value less than the second reference value, when the controller concludes that a connection of the external electronic device to the apparatus is released after controlling the relay to open.

7. The apparatus of claim 6, wherein the controller is configured to control the relay to close, when the controller concludes that the SOC value of the battery is greater than the third reference value less than the second reference value.

8. The apparatus of claim 6, wherein the controller is configured to control the relay to open, when the controller concludes that the SOC value of the battery is less than or equal to the third reference value less than the second reference value.

9. The apparatus of claim 4, wherein the controller is configured to determine whether a connection of the external electronic device to the apparatus is released, when the controller concludes that the SOC value of the battery is less than a second reference value greater than the first reference value due to charging of the battery using the power supplied from the external electronic device.

10. The apparatus of claim 9, wherein the controller is configured to charge the battery using the power supplied from the external electronic device, when the controller concludes that the connection of the external electronic device to the apparatus is not released, in a state where the SOC value of the battery is less than the second reference value greater than the first reference value.

11. A method for controlling a vehicle, the method including:
controlling, by a controller of an apparatus for controlling the vehicle, a relay of the apparatus to close based on a power supplied from a battery of the apparatus or a power supplied from an external electronic device, when the controller concludes that a state of charge (SOC) value of the battery is less than a first reference value and a door of the vehicle is opened; and
charging, by the controller, the battery with the power supplied from the external electronic device.

12. The method of claim 11, further including:
controlling, by the controller, the relay to open, when the controller concludes that the external electronic device is not connected to the apparatus within a predetermined time period after controlling the relay to close based on the power supplied from the battery.

13. The method of claim 12, further including:
determining, by the controller, whether the battery is being charged depending on whether a charging current supplied from the external charging device is greater than or equal to a reference value, when the controller concludes that external charging device is connected to the apparatus within the predetermined time period after controlling the relay to close based on the power supplied from the battery.

14. The method of claim 11, further including:
controlling, by the controller, the relay to open, when the controller concludes that the battery is not being charged after controlling the relay to close based on the power supplied from the external electronic device.

15. The method of claim 11, further including:
controlling, by the controller, the relay to open, when the controller concludes that the SOC value of the battery is greater than or equal to a second reference value greater than the first reference value due to charging of the battery using the power supplied from the external electronic device.

16. The method of claim 15, further including:
determining, by the controller, whether the SOC value of the battery is greater than a third reference value less than the second reference value, when the controller concludes that a connection of the external electronic device to the apparatus is released after controlling the relay to open.

17. The method of claim 16, further including:
controlling, by the controller, the relay to close, when the controller concludes that the SOC value of the battery is greater than the third reference value less than the second reference value.

18. The method of claim 16, further including:
controlling, by the controller, the relay to open, when the controller concludes that the SOC value of the battery is less than or equal to the third reference value less than the second reference value.

19. The method of claim 14, further including:
determining, by the controller, whether a connection of the external electronic device to the apparatus is released, when the controller concludes that the SOC value of the battery is less than a second reference value greater than the first reference value due to charging of the battery using the power supplied from the external electronic device.

20. The method of claim 19, further including:
charging, by the controller, the battery using the power supplied from the external electronic device, when the controller concludes that the connection of the external electronic device to the apparatus is not released, in a state where the SOC value of the battery is less than the second reference value greater than the first reference value.
